(19) United States
(12) Patent Application Publication
(10) Pub. No.: US 2012/0023863 A1
(43) Pub. Date: Feb. 2, 2012

(54) Method And Elevator Arrangement

(75) Inventors: Gert Van Der Meijden, Otterlo (NL); Jos Van Den Heuvel, Nn's-Hertogenbosch (NL)

(73) Assignee: Kone Corporation, Helsinki (FI)

(21) Appl. No.: 13/200,946

(22) Filed: Oct. 5, 2011

Related U.S. Application Data
(63) Continuation of application No. PCT/FI2010/000023, filed on Apr. 6, 2010.

(30) Foreign Application Priority Data
Apr. 6, 2009 (FI) 20090134

(51) Int. Cl. B66B 9/187; B66B 9/16; E04G 21/14

(52) U.S. Cl. 52/741.1; 187/254; 182/129

(57) ABSTRACT

Method for constructing an elevator, more particularly an elevator that is used during the construction-time of the building, in which method the range of movement in the elevator hoistway of the elevator car of the elevator is changed in steps to extend higher in the elevator hoistway with stepped lifts of the supporting platform of the elevator car, and in which method the supporting platform is lifted higher in the elevator hoistway with hoisting means, and the support force needed for the lift is taken from the building via a support structure. In the method the supporting platform is moved in the longitudinal direction of the elevator hoistway while being supported on a support structure that is supported immovably on the building such that the point for taking support from the support structure moves upwards in connection with the lifting of the supporting platform.

### CROSS-REFERENCE TO RELATED APPLICATIONS

This is a Continuation of PCT/FI2010/000023 filed on Apr. 6, 2010 which is an International Application claiming priority from FI 20090134 filed on Apr. 6, 2009, the entire contents of which are hereby incorporated by reference.

### FIELD OF THE INVENTION

The object of the invention is a method as defined in the preamble of claim 1 and an elevator arrangement as defined in the preamble of claim 13.

### BACKGROUND OF THE INVENTION

In connection with so-called jump-lifts, the bottom part of an elevator hoistway is taken into the use of the elevator before the building has been completed. In this case the upper parts of the building and of the elevator hoistway can be constructed at the same time as an elevator moving in the bottom part of the elevator hoistway already serves people on the lower floors of the building. Generally in jump-lifts the elevator car moving in the lower parts of the elevator hoistway is supported and moved during construction-time use with a hoisting machine supported on a supporting platform in the elevator hoistway, which supporting platform thus forms a machine room platform. The installation work in the upper parts of the elevator hoistway above this machine room platform is done from a movable platform or corresponding in the elevator hoistway, which installation work comprises, among other things, the installation of guide rails and electrifications in the elevator hoistway. When the building and the elevator hoistway under construction above the machine room platform have reached a sufficient stage of completion, the completed part of the elevator hoistway can be taken into use. In this case a jump-lift is performed, wherein the machine room platform is raised higher in the elevator hoistway. A worksite crane used in the construction of the building is conventionally used for the jump-lift. One problem with this type of arrangement is that the worksite crane is not always available when needed. This type of solution is presented in, among others, publication GB1194618. Another suggested method for performing the lifting of a machine room platform in connection with a jump-lift is presented in publication EP1583710B1. In the solution in question the vertical support force needed for lifting is taken from the guide rails that are already installed, along which the load is transmitted to the building.

The weight of the machine room platforms combined with the weight of the parts of the elevator supported by the machine room has increased owing to, among other things, buildings that are taller than before. Owing to the very great travel heights of modern elevators, the machine size and rope masses, among other things, are so great that the hoisting capacity needed to perform the last jump-lifts is extremely large. For the same reason, the support needed for the lifting must be robustly made. The aforementioned solution supported on the guide rails cannot, for this reason, be used in all cases, because a weight that is heavier than the machine room platforms cannot be allocated to rest on the guide rails.

Prior-art solutions also exist in which a machine room platform that supports the elevator car is lifted with a hoisting device arranged to act between the machine room platform and a support structure that is higher in the elevator hoistway. This can be e.g. a hydraulic hoist such as in publication WO0007923A1. One problem in the solution in question is that the hoisting apparatus is large in size, complex, expensive to manufacture and laborious to install. One drawback, among others, is that the lift requires a long stroke length of the hydraulic hoist, in which case the apparatus is expensive to manufacture, takes space and is heavy.

### AIM OF THE INVENTION

The aim of the invention is to eliminate the aforementioned drawbacks, among others, of prior-art solutions. More particularly the aim of the invention is to produce an improved construction-time elevator arrangement and method, by utilizing which the construction-time operating range of an elevator can be extended upwards in the building. The aim of the invention is further to produce one or more of the following advantages, among others:
A solution is achieved with which the very large masses of an elevator can be moved in a jump-lift with a simple arrangement.
Elevator installation is independent of the worksite crane for the building.
A solution is achieved in which a very heavy supporting platform with the parts connected to it can be moved/supported with light hoisting devices of small size.
A solution is achieved in which the mass of the support structure needed for moving the supporting platform is small, in which case it can be moved with light hoisting devices and with simple arrangements, e.g. with a hoisting device reserved for moving a working platform operating in the upper parts of the elevator hoistway.
A heavy lifting beam is not needed, nor are complex arrangements for moving the lifting beam.
The length of the jump lift can be selected to be that desired.
A climbing solution is achieved, which does not need to be supported on the guide rails of the elevator car or of the counterweight, so that e.g. the guide rails do not need to be finely positioned after a jump-lift.
A solution is achieved with which installation is rapid, because e.g. the preliminary preparations speed it up compared to earlier.
During construction-time normal use of the elevator a load is not exerted on the guide rails.
The hoisting apparatus used for the jump-lift and the machine room take up little space in the vertical direction of the elevator hoistway.
The structure of the supporting platform is light.
Less materials are used in the manufacture of the hoisting apparatus, the supporting platform and the support structure, more particularly less steel.

### SUMMARY OF THE INVENTION

The method according to the invention is characterized by what is disclosed in the characterization part of claim 1. The arrangement according to the invention is characterized by what is disclosed in the characterization part of claim 13. Other embodiments of the invention are characterized by what is disclosed in the other claims. Some inventive embodiments are also presented in the descriptive section and in the drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments can be applied within the framework of the basic inventive concept in conjunction with other embodiments.

According to the invention, in the method for constructing an elevator, more particularly an elevator that is used during the construction-time of a building, the range of movement in the elevator hoistway of the elevator car of the elevator is changed in steps to extend upwards in the elevator hoistway with stepped lifts of the supporting platform of the elevator car, and in which method the supporting platform is lifted upwards in the elevator hoistway with hoisting means, and the support force needed for the lift is taken from the building via a support structure. In the method the supporting platform is moved in the longitudinal direction of the elevator hoistway while being supported on a support structure that is supported immovably on the building such that the point for taking support from the support structure moves upwards in connection with the lifting of the supporting platform. Thus an independent, light and compact structure is produced. The structure thus achieved is able to climb, if necessary, upwards in the hoistway. With the solution also the other aforementioned advantages are achieved.

In one embodiment of the invention the support structure is a rigid structure, the support element of which is preferably an H-beam, which support structure together with support element is supported at least during a lift immovably on the building at the desired point.

In one embodiment of the invention the support element is an elongated beam in the longitudinal direction of the elevator hoistway, preferably a metal beam. Thus it is simple, light, inexpensive and easy to fix temporarily.

In one embodiment of the invention the support element is an elongated profile beam in the longitudinal direction of the elevator hoistway. Thus it can be used e.g. for guidance during a lift, among other things.

In one embodiment of the invention after the lift the structures of the elevator hoistway above the supporting platform are installed before performing the next lift, and between lifts the elevator car is taken into use to serve users at least in a part of those floors of the building which are below the supporting platform.

In one embodiment of the invention the lifting of the supporting platform during a lift is guided by means of the shape of the support element of the support structure. In this way a safe lift is achieved.

In one embodiment of the invention the lift is performed in steps by moving the point at which support is taken from the support structure, more particularly from its support element, in steps upwards. In this way a climbing solution is achieved that is essentially independent of other hoisting devices.

In one embodiment of the invention after the lift the supporting platform is supported in its position so that it does not move in relation to the building and the support structure is moved upwards in the elevator hoistway. In this way the size of the support structure, more particularly of its support element, can be fitted to be advantageous. The solution is light, inexpensive and compact. With the solution an elevator can be formed to be very high without needing very long structures in the longitudinal direction of the hoistway.

In one embodiment of the invention the support structure is suspended on a second support structure and on second hoisting means in the elevator hoistway that are above the support structure, and the support structure is moved upwards in the elevator hoistway by means of them.

In one embodiment of the invention one lift is essentially one floor level in length.

In one embodiment of the invention, in the method at least the following phases are performed:

A) The supporting platform (3) is lifted in relation to the support structure (6) that is fixed to the elevator hoistway (1) while being supported on the support means (Wc2) that is supported at a first height on the support element (P), which support means (Wc2) supports the hoisting device (HC) on the support element (P),
B) The supporting platform is locked so as to be immovable in relation to the elevator hoistway, e.g. by supporting it on an immovable structure of the building, such as on the support structure (6) or on the elevator hoistway,
C) The support means (Wc2) is moved upwards, and is supported on the support element at a second height,
D) the locking of the supporting platform is released,
E) The supporting platform is lifted with the hoisting device in relation to the support element that is immovably fixed to the elevator hoistway while being supported on the support means (Wc2) that was moved to the second height,
F) The supporting platform is locked, so as to be immovable in relation to the elevator hoistway, e.g. by supporting it on an immovable structure, such as on the elevator hoistway or on some other structure of the building,
G) the movable support structure is lifted upwards in the elevator hoistway, and the support structure is fixed to an immovable structure, such as to the elevator hoistway (1).

In one embodiment of the invention the method comprises at least one, preferably a plurality of, phases E′ between the phase E and F, in which phase E′ the support means (Wc2) is moved and supported at the next height on a support element and the supporting platform is lifted in relation to the support structure fixed to the elevator hoistway while being supported on support means (Wc2).

In one embodiment of the invention between jump-lifts second hoisting means are used to move a working platform in the elevator hoistway under construction between the second support structure and the support structure.

In one embodiment of the invention two hoisting devices that lift simultaneously are used in the lifting, and the hoisting speed of the hoisting devices used in the lifting are preferably synchronized with synchronization means.

According to the invention, the elevator arrangement, more particularly in a construction-time elevator, comprises an elevator hoistway, an elevator car, hoisting roping (11) for moving the elevator car (2) in the elevator hoistway, a supporting platform, for supporting the elevator car below it via the hoisting roping, means for moving the hoisting roping, such as e.g. a traction sheave and an electric motor, a movable support structure in the elevator hoistway, hoisting means, which are arranged to lift the supporting platform upwards in the elevator hoistway while being supported by the support structure. The support structure comprises an elongated support element in the longitudinal direction of the elevator hoistway, and hoisting means are arranged to rest on the support element such that the point at which the support is taken from the support element must be moved in the longitudinal direction of the support element.

In one embodiment of the invention the support structure is a rigid structure, the support element of which is preferably an H-beam, which support structure together with support element is supported at least during a lift immovably on the building at a desired point.

In one embodiment of the invention the support element extends in the longitudinal direction of the elevator hoistway by at least one floor-to-floor distance, preferably by more, most preferably by approx. 4 meters.

In one embodiment of the invention the support element extends in the longitudinal direction of the elevator hoistway 1-5 meters, preferably 3.5-5 meters, most preferably approx. 4 meters.

In one embodiment of the invention the hoisting means comprise a hydraulic hoisting device and means for supporting the hoisting device on an elongated support element such that the point at which the support is taken from the support element must be moved in the longitudinal direction of the support element.

In one embodiment of the invention the supporting platform comprises support means, which are arranged to rest on the support element such that the point at which the support is taken from the support element must be moved.

In one embodiment of the invention the arrangement comprises a plurality of hoisting devices, each of which is arranged to take the support force needed for lifting from the building via its own support element.

In one embodiment of the invention the elevator arrangement comprises a second support structure in the elevator hoistway above the support structure, and second hoisting means for lifting the support structure in the elevator hoistway while being supported on the second support structure, which second support structures and second hoisting means are preferably also arranged to move a working platform in the elevator hoistway under construction in the section of the elevator hoistway between the second support structure and the support structure.

In one embodiment of the invention the support structure comprises a plurality of elongated support elements that are at a distance from each other in the horizontal direction and that extend in the longitudinal direction of the elevator hoistway.

In one embodiment of the invention the support element is a guide rail profile, preferably an H-beam, guided by which the supporting platform is arranged to be lifted.

In one embodiment of the invention the support means for supporting the hoisting device and/or the supporting platform on the support element comprises movable support units, which can be moved to extend inside the vertical projection of the profile structure of the support element, and supported by which the supporting platform and/or the hoisting device can be brought to rest supported by the support element (P), and the support element comprises apertures for this purpose, into which apertures the support units can be moved and supported.

In one embodiment of the invention support means are connected to both the supporting platform and the hoisting device for supporting the supporting platform and/or the hoisting device on the support element, which support means comprise a movable support unit for being supported on the support element, and the support unit is arranged to allow the upwardly directed movement of the hoisting device and/or the supporting platform and to prevent downwardly directed movement.

In one embodiment of the invention the hoisting device is a hydraulic hoist.

In one embodiment of the invention the supporting platform can be moved between an extended position and a contracted position, in which extended position the supporting platform rests on the building in the vertical direction, and in which contracted position the supporting platform does not rest on the building in the vertical direction.

In one embodiment of the invention it comprises at least two hoisting devices and means for synchronizing the hoisting speeds of the hoisting devices, such as e.g. measuring means and comparing means of the speeds, e.g. a tachometer and a microprocessor and a control of the hoisting device, which controls the hoisting devices on the basis of the result of the comparing means.

In one embodiment of the invention the hoisting device comprises the rotor of a linear motor, and the support element forms a stator for the rotor of the hoisting device, or vice versa.

### LIST OF FIGURES

In the following, the invention will be described in detail by the aid of some embodiments with reference to the attached drawings, wherein

FIG. 1 presents a diagrammatic side view of a construction-time elevator arrangement of an elevator in a building according to one embodiment of the invention, in which the lift is arranged to be performed with a method according to the invention.

FIG. 2 presents a three-dimensional and diagrammatic view of a construction-time elevator arrangement of an elevator in a building according to one embodiment of the invention, in which the lift is arranged to be performed with a method according to the invention.

FIGS. 2-7 present the different phases of the method implemented with the arrangement of FIG. 2.

FIGS. 8a and 8b present the support means according to the invention.

### DETAILED DESCRIPTION OF THE INVENTION

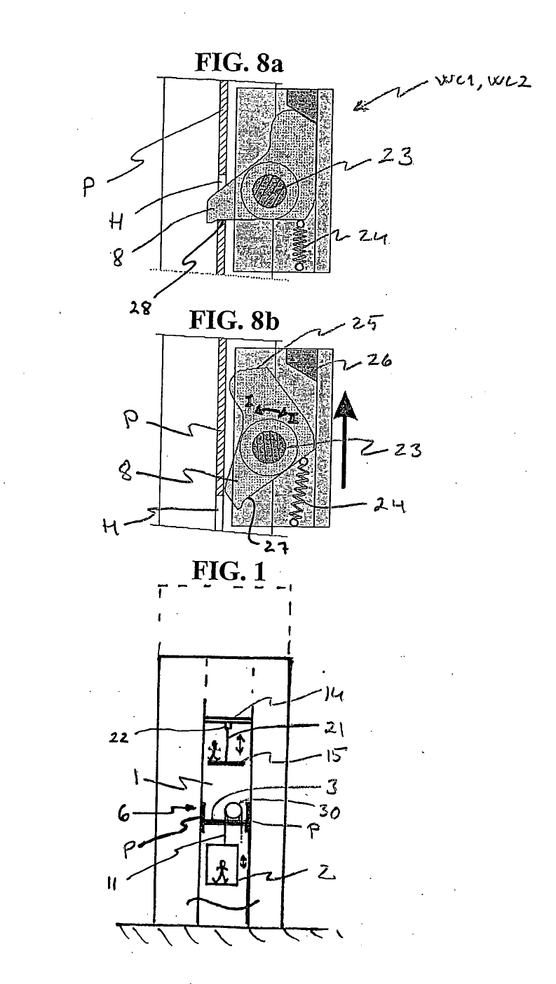

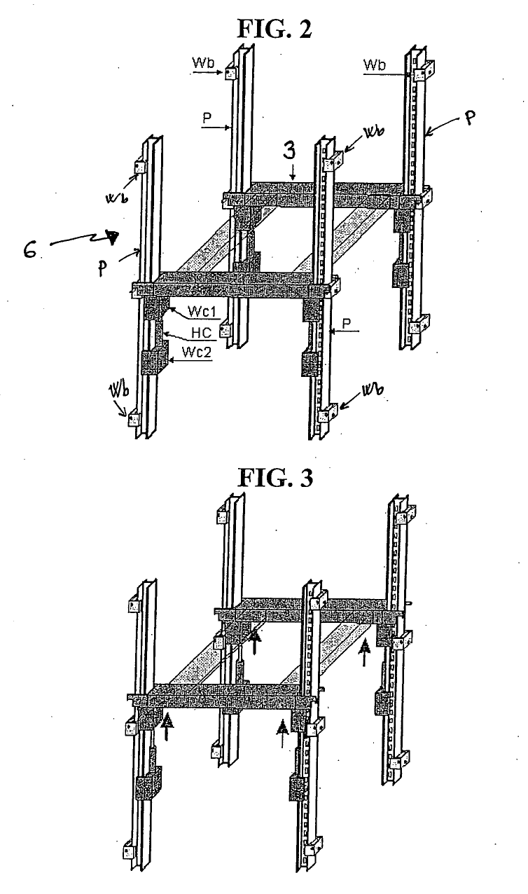

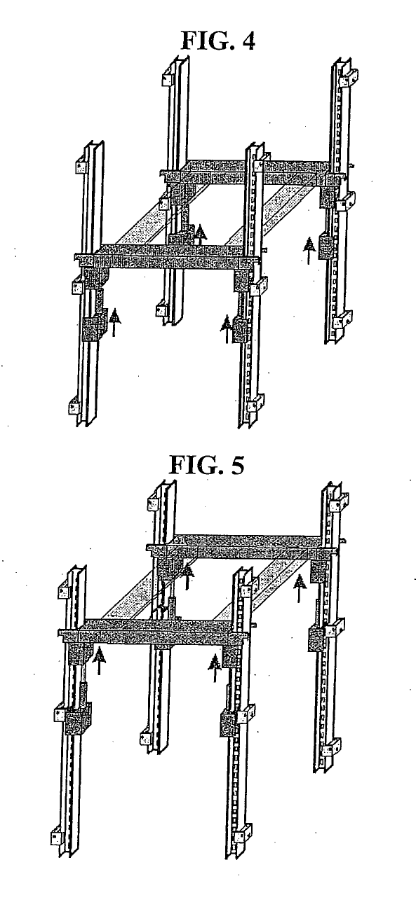

The arrangement comprises a supporting platform 3 fitted into an elevator hoistway 1, which supporting platform supports the elevator car 2 below it via hoisting roping 11, which elevator car 2 is in use to serve passengers in the lower floors of the building in the manufacturing phase of the building. After the construction of the elevator hoistway has progressed to a sufficient stage of completion, utilizing the arrangement presented a jump-lift can be performed for changing the range of movement of the elevator car 2 in steps so that it reaches to higher in the elevator hoistway 1. This is arranged to be performed by lifting the supporting platform 3 upwards in the elevator hoistway 1. For this purpose the arrangement according to the invention comprises a movable support structure 6 supported on the wall structures of the elevator hoistway extending to above the supporting platform 3, as well as hoisting means HC, Wc2 arranged to act between the support structure 6 and the supporting platform 3, which hoisting means are arranged to lift the supporting platform 3 upwards in the elevator hoistway 1 while being supported by the support structure 6. The support structure is supported on the wall structures or on the beams of the elevator hoistway 1 for taking the vertical support force needed for lifting the supporting platform 3 from the building. The final height of the building is marked in FIG. 1 with a dashed line. The arrangement comprises a second support structure 14 in the elevator hoistway above the supporting platform, and second hoisting means (21,22), supported by which the support structure can be moved upwards in the elevator hoistway 1 and/or an installation platform 15 can be moved above the supporting platform. The supporting platform 3 can be moved in the vertical-direction in the elevator hoistway and can be locked at the desired height because it can be moved between an extended position and a contracted position, in which extended position the supporting platform rests on the building in the vertical direction, and in which contracted position the supporting platform does not rest on the building in the vertical direction. This can be implemented e.g. such that in the extended position the support unit comprised in the supporting platform extends in the horizontal direction farther away from the supporting platform 3 than in the contracted position, and to extend in the extended position against the top surface that is supported on the building. This can be implemented e.g. with an arrangement in which the support unit is connected to the frame structure of the supporting platform telescopically or in a folding manner. The supporting platform rests on these support units between jump-lifts when the elevator car 2 is used for providing service. The arrangement/method presented in FIG. 1 is advantageous to implement in respect of its details in the manner presented in FIGS. 2-8b.

FIG. 2 presents a diagrammatic side view of a construction-time elevator arrangement of an elevator in a building according to one embodiment of the invention, in which the lift is arranged to be performed with the method according to the invention. In the arrangement the supporting platform 3 is supported on the building via the support elements P of the support structure by supporting the supporting platform on them in a detachable manner via the support means Wc1. The supporting platform 3 preferably supports the hoisting machine 30 (not presented) of the elevator, but not necessarily because the hoisting machine 30 could also be elsewhere. The arrangement comprises hoisting devices HC, each of which is supported on its own support element via the detachable support means Wc2. The support element P is an elongated profile structure, preferably an H-beam, and comprises a plurality of apertures at a distance from each other, in which apertures the support means Wc1 and/or Wc2 can be supported. Each hoisting device HC is a hydraulic hoist, the piston of which moves in a hydraulic cylinder and is able to exert an essentially large force on the supporting platform to move it. The hoisting device HC is connected essentially in a fixed manner to the support means Wc1 and Wc2, either directly or indirectly, e.g. via the supporting platform.

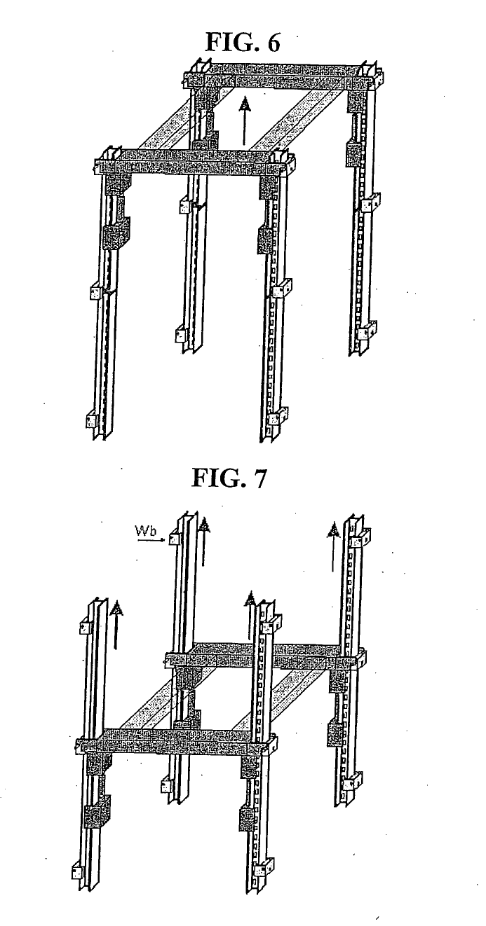

In the method for constructing an elevator, more particularly an elevator that is used during the construction-time of a building, more particularly for moving goods or people, the range of movement in the elevator hoistway 1 of the elevator car 2 of the elevator is changed in steps to extend higher in the elevator hoistway 1 with stepped lifts of the supporting platform 3 that supports the elevator car 2 of the elevator in the elevator hoistway 1 with the arrangements of FIGS. 2-7 utilizing e.g. the support units according to FIGS. 8a-8b. The supporting platform is preferably arranged in the elevator hoistway 2 with the arrangement according to FIG. 1. In the method the supporting platform 3 is lifted upwards in the elevator hoistway with hoisting means HC, Wc2, and the support force needed for the lift is taken from the building via a support structure 6. In the method the supporting platform 3 is moved upwards in the longitudinal direction of the elevator hoistway 1 while being supported on a support structure 6 that is supported immovably on the building such that the point for taking support from the support structure moves upwards in connection with the lifting of the supporting platform.

FIG. 3 illustrates a situation of the method, in which the hoisting device HC is supported on support elements P with support means Wc2 and pushes the supporting platform 3 upwards. After the hoisting device HC has lifted the supporting platform the distance of a stroke length, the supporting platform 3 is locked to the support elements P by means of the support means Wc1, the support unit 8 of which engages (e.g. through spring-loading) into an aperture H of the support element P. After this the hoisting device HC pulls itself up while being supported by the support unit 8 of the support means Wc1 as presented in FIG. 4. For this purpose the top end of the hoisting device is fixed to the installation platform or to the support means Wc1. The hoisting device is fixed also to the lower support means Wc2 and when pulling itself upwards the hoisting device HC pulls along with it the support means Wc2, the support unit 8 comprised in which permits movement of the support means Wc2 directed upwards in relation to the support element P. When the hoisting device HC has pulled itself up the distance permitted by its movement allowance and the support units 8 are at the point of an aperture H and pushed inside the aperture H, e.g. through spring-loading, the next move of the supporting platform 3 can be performed by pushing the supporting platform 3 upwards as presented in FIG. 5. The support unit 8 of the support means Wc1 is similar to Wc2 of the hoisting device, so that it allows upward movement of the supporting platform, e.g. automatically by means of the shaping and by means of spring-loading that gives when lifting. The supporting platform 3 is moved upwards in this way the desired amount by repeating the procedures described above. The supporting platform and the hoisting device thus, in a way, climb along the elongated support element taking support in turns from the support element such that when one is supported on a support element, the other can move upwards while being supported on it. FIG. 6 presents the arrangement in the final phase of the lift, in which the supporting platform 3 is supported immovably on the building. After this the procedures depend on whether it is desired to lift the supporting platform 3 still higher. If the supporting platform is at the desired height in the elevator hoistway 1, the elevator car can be taken into use after supporting the supporting platform on the building. If it is desired to lift the supporting platform still, after supporting the supporting platform on the building the support means Wc1 and Wc2 are released from the support element and the support means Wc2 as well as the hoisting device are left to be suspended from the supporting platform. The support structure 6 together with support element P is supported by the second hoisting device 22 in the elevator hoistway, the fixing Wb of the support structure is detached from the building, and the support structure 6 is lifted upwards in the elevator hoistway as presented in FIG. 7. After this the support structure 6 is again fixed to the building with a fixing Wb for the next lift, which is performed as described earlier. In connection with this also the support means Wc2 and the hoisting device HC are again fixed to the support element P at a first height. The lifts are continued depending on the need for the total height of the jump-lift. During the lift the elevator car is preferably fixed to the supporting platform and the counterweight is in its extreme position at the bottom. The lengths of the ropings are increased during the lifts according to need. The height of the lift is preferably one floor, in which case the support element extends in the longitudinal direction of the elevator hoistway, preferably 3.5-5 meters, most preferably approx. 4 meters. In this case a lift of one floor-to-floor length can be executed with one lift. The support element 3 is preferably shaped to possess the type of profile structure that it can function as a guide surface to guide the lifting of the supporting platform. For this purpose it is advantageous that guidance means corresponding to the support element P are fixed to the supporting platform, and that the support element comprises at least one essentially flat surface that continues unbroken and straight for a distance essentially the length of the lift, preferably essentially the aforementioned 1-5 m, more preferably 3.5-5 m, most preferably 4 m.

FIG. 8a presents a support means Wc1, Wc2 according to the invention, the support unit of which is placed into the aperture H of the support element P. In FIG. 8b the support unit has been moved away from the point of the aperture. The support means comprises a movable support unit 8, which is arranged in a spring-loaded manner to push towards the extended position, in which position the support surface 27 of the support unit faces essentially downwards. The support unit 8 is fitted to settle face-to-face with the upward facing support surface 28 of the support element P as viewed from the top. The support unit is arranged to be moved out of the extended position by pushing against the spring force, which pushing can be exerted onto the support unit 8 from above by the action of an elevator or a part of the building that is separate from the support element, or from a structure supported by it, such that the support unit rotates in a first direction. In the figure the support element P is arranged to push the support unit and to bend the support unit out of the extended position against the spring force when the support means are moved upwards so that the support unit rises along with the support means. The support unit comprises a movement allowance, which limits the bending of the support unit so that the support unit is not able to bend in the second direction II from the extended position but instead only in the contracting direction (the first direction I). The movement allowance is limited by means of the countersurface of the support means Wc1, Wc2, against which the countersurface 25 of the support unit 8 is arranged to settle when the support unit has moved into the extended position, The bending of the support unit is enabled by means of a pivot axis 23 supported on the support means. The spring 24 is supported on the support means Wc1, Wc2 so that it continuously attempts to move the support unit towards the extended position, i.e. the position in which the support unit is intended to be when it is supporting the support means and the structure, the support of which is primarily the aim, fixed to the same. The support means according to FIGS. 8a-8b is used preferably in the solutions of FIGS. 1-7 for supporting the supporting platform and/or the hoisting device on the building and/or on a support element P of the support structure P. The support means solution presented can form a separate invention to the other solutions of this application. The solution is suited for use e.g. for locking the machine room platform/supporting platform or hoisting beams of jump-lifts to the elevator hoistway so that they are immovable downwards. In this case, in place of the part P of FIGS. 8a-b there can be any structure whatsoever of the elevator hoistway that possesses a support surface facing upwards capable of providing sufficient support. The support unit 8, for its part, is in this case fixed in a bendable manner to that structure (supporting platform, hoisting device, machine room platform, hoisting beam), which it is desired to support in its position with the solution. The support surface 28 can be arranged on any fixed structure whatsoever of the elevator hoistway.

The elevator hoistway is formed preferably inside the building and is vertical. The guide rails (not shown) of the elevator car in the part of the elevator hoistway below the supporting platform are already fixed to the walls of the elevator hoistway. Above the support structure, where the elevator hoistway is unfinished, the work to install the car guide rails can be performed from a working platform 15. The elevator under construction will come to form the final elevator of the building, preferably a passenger elevator or a freight elevator, when the building is completed.

The hoisting device HC does not necessarily need to be a hydraulic hoist, but instead it can be e.g. pneumatic. The inventive concept of being supported on an elongated support element can also be used to advantage with a solution wherein the rotor of a linear motor is connected to the supporting platform, and in which an elongated support element forms a stator for the aforementioned rotor, or vice versa.

The support structure 6 comprises preferably, but not necessarily, more than one support element P and means Wb for fixing them to the building and hoisting devices HC. The support elements P of the support structure 6 can be connected to each other, but they can also be separate to facilitate moving.

In this application the term hoisting roping refers to hoisting roping that comprises a rope, chain, belt or some other corresponding. It is obvious to the person skilled in the art that the invention is not limited to the embodiments described above, in which the invention is described using examples, but that many adaptations and different embodiments of the invention are possible within the frameworks of the inventive concept defined by the claims presented below.

Thus, for example, it is obvious that the support unit can rest on the support element in other ways than by pushing into apertures, e.g. by becoming caught utilizing a unidirectional wedging principle such that wedging permits movement of the support means only in one direction, e.g. with the prior-art principle known from safety gears. It is also obvious that the supporting platform can support the elevator car via the diverting pulleys and/or via the hoisting machine on the supporting platform. When the hoisting machine is on the supporting platform, the supporting platform forms a machine room platform. It is also obvious that although the support elements presented are preferably separate parts from the car guide rails, car guide rails could, if necessary, alternatively be utilized in the method instead of them.

1. Method for constructing an elevator, more particularly an elevator that is used during the construction-time of the building, in which method the range of movement in the elevator hoistway of the elevator car of the elevator is changed in steps to extend higher in the elevator hoistway with stepped lifts of the supporting platform of the elevator car, and in which method the supporting platform is lifted higher in the elevator hoistway with hoisting means, and the support force needed for the lift is taken from the building via a support structure, wherein the method the supporting platform is moved in the longitudinal direction of the elevator hoistway while being supported on a support structure that is supported immovably on the building such that the point for taking support from the support structure moves upwards in connection with the lifting of the supporting platform.

2. Method according to claim 1, wherein the support structure is a rigid structure, which support structure together with support element is supported at least during a lift immovably on the building at a desired point.

3. Method according to claim 1, wherein during a lift the lifting of the supporting platform is guided by means of the shape of the support element of the support structure.

4. Method according to claim 1, wherein the lift is performed in steps by moving the point at which support is taken from the support element of the support structure in steps upwards.

5. Method according to claim 1, wherein after the lift the supporting platform is supported in its position so that it does not move in relation to the building and the support structure is moved upwards in the elevator hoistway.

6. Method according to claim 1, wherein the support element is an elongated beam in the longitudinal direction of the elevator hoistway, preferably a metal beam.

7. Method according to claim 1, wherein the support element is an elongated profile beam in the longitudinal direction of the elevator hoistway.

8. Method according to claim 1, wherein the support element is an H-beam.

9. Method according to claim 1, wherein the support structure is suspended from a second support structure and from second hoisting means above the support structure in the elevator hoistway, and the support structure (6) is moved upwards in the elevator hoistway by means of them.

10. Method according to claim 1, wherein one lift is essentially one floor level in length.

11. Method according to claim 1, wherein in the method at least the following phases are performed:
A) The supporting platform is lifted in relation to the support structure that is fixed to the elevator hoistway while being supported on the support means that is supported at a first height on the support element of the support structure,
B) The supporting platform is locked so as to be immovable in relation to the elevator hoistway, e.g. by supporting it on an immovable structure of the building, such as on the support structure or on the elevator hoistway,
C) The support means is moved upwards, and it is supported on the support element at a second height,
D) the locking of the supporting platform is released,
E) The supporting platform is lifted with the hoisting device in relation to the support element that is immovably fixed to the elevator hoistway while being supported on the support means that was moved to the second height,
F) The supporting platform is locked so as to be immovable in relation to the elevator hoistway, e.g. by supporting it on an immovable structure of the building, such as on the elevator hoistway or on some other structure of the building,
G) the movable support structure is lifted upwards in the elevator hoistway, and the support structure is fixed to an immovable structure, such as to the elevator hoistway.

12. Method according to claim 1, wherein between jump-lifts second hoisting means are used to move a working platform in the elevator hoistway under construction between the second support structure and the support structure.

13. Elevator arrangement, more particularly in a construction-time elevator, which arrangement comprises:
an elevator hoistway,
an elevator car,
hoisting roping for moving the elevator car in the elevator hoistway,
a supporting platform, for supporting the elevator car below it via the hoisting roping, means for moving the hoisting roping, such as e.g. an electric motor and a traction sheave,
preferably a movable support structure in the elevator hoistway,
hoisting means, which are arranged to lift the supporting platform upwards in the elevator hoistway while being supported by the support structure,
wherein the support structure comprises an elongated support element in the longitudinal direction of the elevator hoistway, and hoisting means, which are arranged to rest on the support element such that the point at which the support is taken from the support element must be moved in the longitudinal direction of the support element.

14. Elevator arrangement according to claim 13, wherein the support structure is a rigid structure, the support element of which is preferably an H-beam, which support structure together with support element is supported at least during a lift immovably on the building at a desired point.

15. Elevator arrangement according to claim 13, wherein the support element extends in the longitudinal direction of the elevator hoistway at least one floor-to-floor distance, preferably slightly more, most preferably approx. 4 meters.

16. Elevator arrangement according to claim 13, wherein the supporting platform comprises support means, which are arranged to rest on the support element such that the point at which the support is taken from the support element must be moved in the longitudinal direction of the support element.

17. Elevator arrangement according to claim 13, wherein it comprises a second support structure above the support structure in the elevator hoistway, and second hoisting means for lifting the support structure in the elevator hoistway while being supported on the second support structure, which second support structures and second hoisting means are preferably also arranged to move a working platform in the elevator hoistway under construction in the part of the elevator hoistway between the second support structure and the support structure.

18. Elevator arrangement according to claim 13, wherein the support element is a guide rail profile, preferably an H-beam, guided by which the supporting platform is arranged to be lifted.

19. Elevator arrangement according to claim 13, wherein the support means for supporting the hoisting device and/or the supporting platform on the support element comprise movable support units, which can be moved to extend inside the vertical projection of the profile structure of the support element, and supported by which the supporting platform and/or the hoisting device can be brought to rest supported by the support element, and in that the support element comprises a plurality of apertures for this purpose, into which apertures the support units can be moved and supported.

20. Elevator arrangement according to claim 13, wherein support means are connected both to the supporting platform and to the hoisting device for supporting the supporting platform and/or the hoisting device on a support element, which support means comprise a movable support unit for being supported on the support element, and in that the support unit is arranged to allow the upwardly directed movement of the hoisting device and/or the supporting platform and to prevent downwardly directed movement.

21. Elevator arrangement according to claim 13, wherein the supporting platform can be moved between an extended position and a contracted position, in which extended position the supporting platform rests on the building in the vertical direction, and in which contracted position the supporting platform does not rest on the building in the vertical direction.
